(19) United States
(12) Patent Application Publication
(10) Pub. No.: US 2024/0005257 A1
(43) Pub. Date: Jan. 4, 2024

(54) SURVEY PLAN GENERATION APPARATUS, SURVEY PLAN GENERATION METHOD, AND PROGRAM

(71) Applicant: FUJIFILM Corporation, Tokyo (JP)

(72) Inventor: Kyota WATANABE, Tokyo (JP)

(73) Assignee: FUJIFILM Corporation, Tokyo (JP)

(21) Appl. No.: 18/469,216

(22) Filed: Sep. 18, 2023

Related U.S. Application Data
(63) Continuation of application No. PCT/JP2022/010194, filed on Mar. 9, 2022.

(30) Foreign Application Priority Data
Mar. 19, 2021 (JP) 2021-046367

(51) Int. Cl. G06Q 10/0639; G01C 15/00

(52) U.S. Cl. CPC G06Q 10/06398; G01C 15/00

(57) ABSTRACT

Provided are a survey plan generation apparatus, a survey plan generation method, and a program which automatically generate a survey plan according to productivity of a surveyor or the like. A survey plan generation apparatus, which generates a survey plan for surveying a plurality of buildings by a plurality of surveyors, acquires a condition which is to be satisfied by the survey plan and includes productivity of the plurality of surveyors, generates the survey plan based on the acquired condition, recalculates the productivity of the plurality of surveyors based on survey performances of the plurality of surveyors in a certain period in a survey performed based on the generated survey plan, and updates the survey plan based on the recalculated productivity.

### CROSS-REFERENCE TO RELATED APPLICATIONS

The present application is a Continuation of PCT International Application No. PCT/JP2022/010194 filed on Mar. 9, 2022 claiming priority under 35 U.S.C § 119(a) to Japanese Patent Application No. 2021-046367 filed on Mar. 19, 2021. Each of the above applications is hereby expressly incorporated by reference, in its entirety, into the present application.

### BACKGROUND OF THE INVENTION

### 1. Field of the Invention

The present invention relates to a survey plan generation apparatus, a survey plan generation method, and a program, and particularly to a technology for generating a survey plan for surveying a plurality of buildings by a plurality of surveyors.

### 2. Description of the Related Art

A technology for automatically generating a work plan to be performed by a worker is known. For example, JP2015-94665A discloses a water leakage survey plan formulation device that formulates a water leakage survey plan for a plurality of areas in which a water pipe network is divided. In addition, WO2019/064379A discloses a personnel arrangement formulation device that formulates a plurality of worker arrangement plans for each step performed in a distribution center.

### SUMMARY OF THE INVENTION

In a case in which the house has suffered from a natural disaster, such as an earthquake, a local government implements a damage certification survey to certify a degree of damage to the house that has suffered from a disaster. In a case of performing this damage certification survey, the local government creates an entire plan for the survey in advance, and estimates a completion expectation date, the required number of persons, a survey schedule for each area, and the like.

In a case in which a catastrophic disaster occurs, the number of survey target houses is tens of thousands, and there are various conditions according to a disaster situation in a case of formulating the survey plan. Examples of the condition include a completion target date, the number of persons that can be procured, an inventory of required materials, a difficulty level of house survey (difference between a wooden structure and a non-wooden structure or the like), and an area that requires priority of the survey. It is difficult to manually create the survey plan for tens of thousands of houses in consideration of these conditions, and there is a problem that the survey is performed with delay or the survey efficiency is lowered.

In addition, in the house damage certification survey, the survey plan differs depending on the productivity of a surveyor or a survey team organized by allocating a plurality of surveyors. However, the devices described in JP2015-94665A and WO2019/064379A have a problem that the productivity is not taken into consideration.

The present invention has been made in view of such circumstances, and is to provide a survey plan generation apparatus, a survey plan generation method, and a program which automatically generate a survey plan according to the productivity of a surveyor or the like.

One aspect of a survey plan generation apparatus for achieving the above object is a survey plan generation apparatus that generates a survey plan for surveying a plurality of buildings by a plurality of surveyors, the apparatus comprising at least one processor, and at least one memory that stores a command to be executed by the at least one processor, in which the at least one processor acquires a condition which is to be satisfied by the survey plan and includes productivity of the plurality of surveyors or productivity of a plurality of survey teams organized by allocating the plurality of surveyors, respectively, generates the survey plan based on the acquired condition, recalculates the productivity of the plurality of surveyors or the productivity of the plurality of survey teams based on survey performances of the plurality of surveyors in a certain period in a survey performed based on the generated survey plan or survey performances of the plurality of survey teams in a certain period, and updates the survey plan based on the recalculated productivity. According to the present aspect, it is possible to automatically generate the survey plan according to the productivity of the surveyor or the like.

It is preferable that the at least one processor generates a plurality of survey plan candidates, displays summary information on the generated plurality of survey plan candidates on a display, and receives selection of the survey plan candidate to be adopted as the survey plan from among the displayed plurality of survey plan candidates by a user. As a result, it is possible for the user to select a desired survey plan candidate from among the plurality of survey plan candidates.

It is preferable that the summary information on the survey plan candidates includes at least one indicator of a total number of survey days or prediction of the number of persons for each of certain periods. As a result, it is possible for the user to select the desired survey plan candidate based on at least one of the indicator of the total number of survey days or the prediction of the number of persons for each of certain periods.

It is preferable that the at least one processor generates the plurality of survey plan candidates according to a plurality of optimization criteria. As a result, it is possible for the user to select the desired survey plan candidate according to the optimization criteria from among the plurality of survey plan candidates.

It is preferable that the survey includes a survey of damage to a plurality of buildings, and the optimization criteria include at least one of a priority to an area in which the damage to the building is large, a priority to an area in which the damage to the building is small, a smallest number of days, or a smallest number of persons. As a result, it is possible to select the survey plan candidate according to appropriate optimization criteria for the survey of damage to the building.

It is preferable that the survey plan includes at least one of a survey schedule, a survey target building list per day, or allocation information on the surveyors or the survey teams. As a result, it is possible to generate an appropriate survey plan.

It is preferable that the at least one processor displays a survey schedule table for each surveyor or survey team of the survey plan on a display, and receives edition of the displayed survey schedule table by a user. As a result, it is possible for the user to generate an optimum survey plan.

It is preferable that the at least one processor receives edition of the survey schedule table by a drag-and-drop operation using a pointing device. As a result, it is possible for the user to edit the survey schedule table with a simple operation.

It is preferable that the condition includes at least one of a target number of days, the number of materials, or a priority area. As a result, it is possible to generate the survey plan that satisfies at least one of the target number of days, the number of materials, or the priority area.

It is preferable that the survey includes a survey of damage to a plurality of buildings, and the at least one processor generates the survey plan based on at least one of building information or damage information for each area. As a result, it is possible to generate an appropriate survey plan for the survey of damage to the building.

It is preferable that the at least one processor generates the survey plan by using at least one shortest path algorithm of bin packing or Dijkstra's algorithm. As a result, it is possible to generate an appropriate survey plan.

It is preferable that the at least one processor displays the generated survey plan and a map of an area in which the plurality of buildings are included, on a display. As a result, it is possible to appropriately present the generated survey plan.

One aspect of a survey plan generation method for achieving the above object is a survey plan generation method of generating a survey plan for surveying a plurality of buildings by a plurality of surveyors, the method comprising a condition acquisition step of acquiring a condition which is to be satisfied by the survey plan and includes productivity of the plurality of surveyors or productivity of a plurality of survey teams organized by allocating the plurality of surveyors, respectively, a survey plan generation step of generating the survey plan based on the acquired condition, a recalculation step of recalculating the productivity of the plurality of surveyors or the productivity of the plurality of survey teams based on survey performances of the plurality of surveyors in a certain period in a survey performed based on the generated survey plan or survey performances of the plurality of survey teams in a certain period, and a survey plan update step of updating the survey plan based on the recalculated productivity. According to the present aspect, it is possible to automatically generate the survey plan according to the productivity of the surveyor or the like.

One aspect of a program for achieving the above object is a program causing a computer to execute the survey plan generation method described above. A computer-readable non-transitory recording medium on which the program is recorded may also be included in the present aspect. According to the present aspect, it is possible to automatically generate the survey plan according to the productivity of the surveyor or the like.

According to the present invention, it is possible to automatically generate the survey plan according to the productivity of the surveyor or the like.

### BRIEF DESCRIPTION OF THE DRAWINGS

FIG. 1 is a schematic diagram of a survey plan generation apparatus.

FIG. 2 is a functional block diagram of a survey plan generation apparatus.

FIG. 3 is a flowchart showing each step of a survey plan generation method according to a first embodiment using the survey plan generation apparatus.

FIG. 4 is a process diagram of each step of the survey plan generation method.

FIG. 5 is an example of an input screen displayed on a display.

FIG. 6 is an example of a plan candidate selection screen displayed on the display.

FIG. 7 is an example of an edition screen displayed on the display.

FIG. 8 is a diagram showing an example in which an allocation area of a certain team and an allocation area of another team are changed.

FIG. 9 is a diagram showing an example in which an allocation area of a certain team and an allocation area of another team are changed.

FIG. 10 is an example of the edition screen on which a survey plan and a map are simultaneously displayed on the display.

FIG. 11 is another example of the edition screen on which the survey plan and the map are displayed simultaneously on the display.

FIG. 12 is an example of a screen of the display on which a completion button is displayed.

FIG. 13 is a flowchart showing each step of a survey plan generation method according to a second embodiment using the survey plan generation apparatus.

FIG. 14 is a flowchart showing each step of the survey plan generation method according to the second embodiment using the survey plan generation apparatus.

FIG. 15 is a flowchart showing each step of the survey plan generation method according to the second embodiment using the survey plan generation apparatus.

FIG. 16 is a flowchart showing each step of the survey plan generation method according to the second embodiment using the survey plan generation apparatus.

FIG. 17 is a process diagram showing a survey plan generation method according to a third embodiment using the survey plan generation apparatus.

FIG. 18 is a diagram showing generation of survey plan candidates.

FIG. 19 is a diagram showing a part of plan summary display G2.

### DESCRIPTION OF THE PREFERRED EMBODIMENTS

Hereinafter, the detailed description of preferred embodiments of the present invention will be made with reference to the accompanying drawings. Here, an example will be described in which a survey plan is generated in a case of performing a damage certification survey of a building after the occurrence of a catastrophic disaster. The building refers to a house, such as a “detached house” and an “apartment house”, but may include a whole building, such as a “store”, an “office”, and a “factory”. Hereinafter, the building will be referred to as “house” without distinguishing the types.

[Configuration of Survey Plan Generation Apparatus]

FIG. 1 is a block diagram of a survey plan generation apparatus 10 according to the present embodiment. The survey plan generation apparatus 10 is implemented by at least one computer. As shown in FIG. 1, the survey plan generation apparatus 10 comprises a processor 12, a memory 14, a communication interface 16, an input interface 18, and a display 20.

The processor 12 executes a command stored in the memory 14. A hardware structure of the processor 12 is various processors as described below. Various processors include a central processing unit (CPU) as a general-purpose processor which acts as various function units by executing software (program), a graphics processing unit (GPU) as a processor specialized in image processing, a programmable logic device (PLD) as a processor of which a circuit configuration can be changed after manufacture, such as a field programmable gate array (FPGA), a dedicated electric circuit as a processor which has a circuit configuration specifically designed to execute specific processing, such as an application specific integrated circuit (ASIC), and the like.

One processing unit may be configured by using one of these various processors, or may be configured by using two or more processors of the same type or different types (for example, a plurality of FPGAs, or a combination of a CPU and an FPGA, or a combination of a CPU and a GPU). Moreover, a plurality of function units may be configured by using one processor. As a first example in which the plurality of function units are configured by using one processor, as represented by a computer such as a client or a server, there is a form in which one processor is configured by using a combination of one or more CPUs and software, and this processor acts as the plurality of function units. As a second example thereof, as represented by a system on chip (SoC), there is a form in which a processor, which implements the functions of the entire system including the plurality of function units by one integrated circuit (IC) chip, is used. As described above, various function units are configured by using one or more of the various processors described above as the hardware structure.

Further, the hardware structure of these various processors is, more specifically, an electric circuit (circuitry) in which circuit elements, such as semiconductor elements, are combined.

The memory 14 stores the command to be executed by the processor 12. The memory 14 includes a random access memory (RAM) and a read only memory (ROM)(which are not shown). The processor 12 executes various types of processing of the survey plan generation apparatus 10 by using the RAM as a work region, executing software by using various programs and parameters including a survey plan generation program stored in the ROM, and using the parameters stored in the ROM and the like.

The communication interface 16 controls wired and wireless communication. The survey plan generation apparatus 10 is connected by the communication interface 16 to be able to transmit and receive data to a communication network, such as the Internet.

The input interface 18 is an input device for a user to input various types of information and a desired instruction to the survey plan generation apparatus 10. The input interface 18 includes a pointing device, such as a mouse, and an input device, such as a keyboard.

The display 20 is a display device for allowing the user to visually recognize the information, such as the generated survey plan. The display 20 displays a screen required for an operation of the input interface 18, and functions as a part that implements a graphical user interface (GUI). A touch panel display may be applied in which the input interface 18 and the display 20 are integrated.

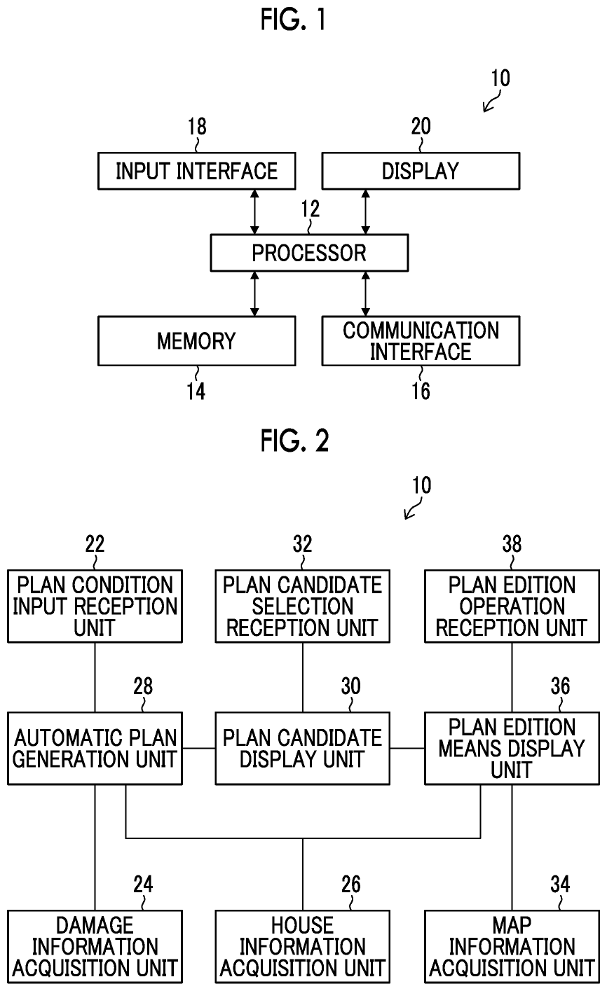

FIG. 2 is a functional block diagram of the survey plan generation apparatus 10. As shown in FIG. 2, the survey plan generation apparatus 10 comprises a plan condition input reception unit 22, a damage information acquisition unit 24, a house information acquisition unit 26, an automatic plan generation unit 28, a plan candidate display unit 30, a plan candidate selection reception unit 32, a map information acquisition unit 34, a plan edition means display unit 36, and a plan edition operation reception unit 38. Each of these functions of the survey plan generation apparatus 10 is implemented by the processor 12.

The plan condition input reception unit 22 receives input of a plan condition to be satisfied by the generated survey plan. In a case in which the user inputs the plan condition by using the input interface 18, the plan condition input reception unit 22 receives the input plan condition. The plan condition includes an expectation value of the productivity each of a plurality of surveyors (the number of surveys per day) or an expectation value of the productivity of each of a plurality of survey teams. The survey team is a group consisting of one or more surveyors organized by allocating the plurality of surveyors, and is a group of the smallest unit that performs a survey. The plan condition may include elements that affect a schedule of the survey plan, such as a target number of days, the number of materials, and a priority area.

The damage information acquisition unit 24 acquires damage information in an area including a house that is a target of the damage certification survey. The damage information acquisition unit 24 may acquire the damage information via the communication interface 16, or may acquire the damage information via the input interface 18. The damage information acquisition unit 24 may acquire the damage information stored in the memory 14.

The house information acquisition unit 26 acquires house information (an example of “building information”) which is information on the house that is the target of the damage certification survey. The house information acquisition unit 26 may acquire the house information via the communication interface 16, or may acquire the house information via the input interface 18. The house information acquisition unit 26 may acquire the house information stored in the memory 14. The house information includes information on distinction between a wooden structure and a non-wooden structure. The wooden structure is a structure in which wood is used as a main part in terms of structural resistance. In addition, the non-wooden structure is a structure other than the wooden structure, and includes a reinforced concrete structure, a steel frame structure, and the like.

The automatic plan generation unit 28 generates a plurality of survey plan candidates according to a plurality of optimization criteria based on the plan condition received by the plan condition input reception unit 22, the damage information acquired by the damage information acquisition unit 24, and the house information acquired by the house information acquisition unit 26. The optimization criteria include at least one of a priority to an area in which the damage is large, a priority to an area in which the damage is small, a smallest number of days, or a smallest number of persons. It should be noted that the area in which the damage is large and the area in which the damage is small refer to an area in which the damage is relatively large and an area in which the damage is relatively small among the areas that are the survey targets, and the determination as to whether the damage is relatively large or small is made based on the number of disaster houses in the area.

Each of the generated survey plan candidates includes a survey schedule, a survey target house list (an example of a “survey target building list”) per day, and allocation information for each survey team. At least one shortest path algorithm of bin packing or Dijkstra's algorithm may be used for the generation of the survey plan candidate.

The plan candidate display unit 30 displays summary information on each of the plurality of survey plan candidates generated by the automatic plan generation unit 28 on the display 20. The summary information on the survey plan candidates includes at least one indicator of a total number of survey days or prediction of the number of persons for each of certain periods.

The plan candidate selection reception unit 32 receives selection of any survey plan candidate of the plurality of survey plan candidates. In a case in which the user selects a desired survey plan candidate from among the plurality of survey plan candidates displayed on the display 20 by using the input interface 18, the plan candidate selection reception unit 32 receives the selected survey plan candidate as the survey plan to be adopted.

The map information acquisition unit 34 acquires map information on the area including the house that is the target of the damage certification survey. The map information acquisition unit 34 may acquire the map information via the communication interface 16, or may acquire the map information via the input interface 18. The map information acquisition unit 34 may acquire the map information stored in the memory 14.

The plan edition means display unit 36 displays the survey plan received by the plan candidate selection reception unit 32 on the display 20 in an editable manner. The plan edition means display unit 36 displays the survey schedule table for each surveyor or survey team of the survey plan on the display 20. The plan edition means display unit 36 may display the map information acquired by the map information acquisition unit 34 on the display 20.

The plan edition operation reception unit 38 receives an edition operation by the input interface 18 of the survey plan displayed by the plan edition means display unit 36 on the display 20. The plan edition operation reception unit 38 receives the edition of the survey schedule table displayed by the plan edition means display unit 36 on the display 20, that is, the edition of the survey schedule table by a drag-and-drop operation using the pointing device (not shown).

### Survey Plan Generation Method: First Embodiment

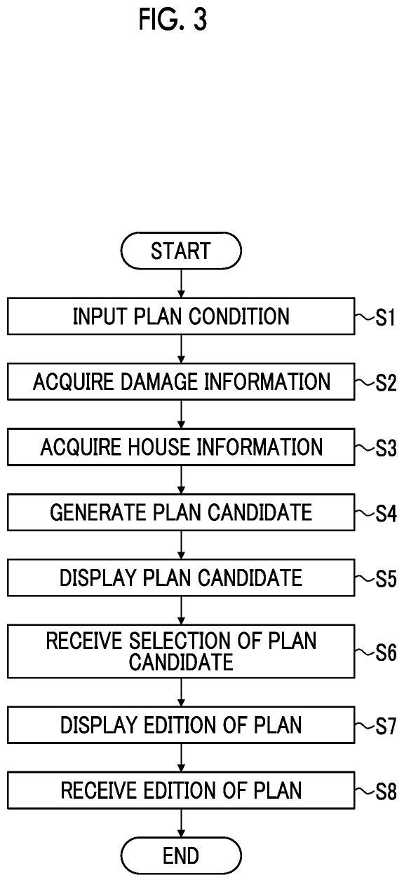

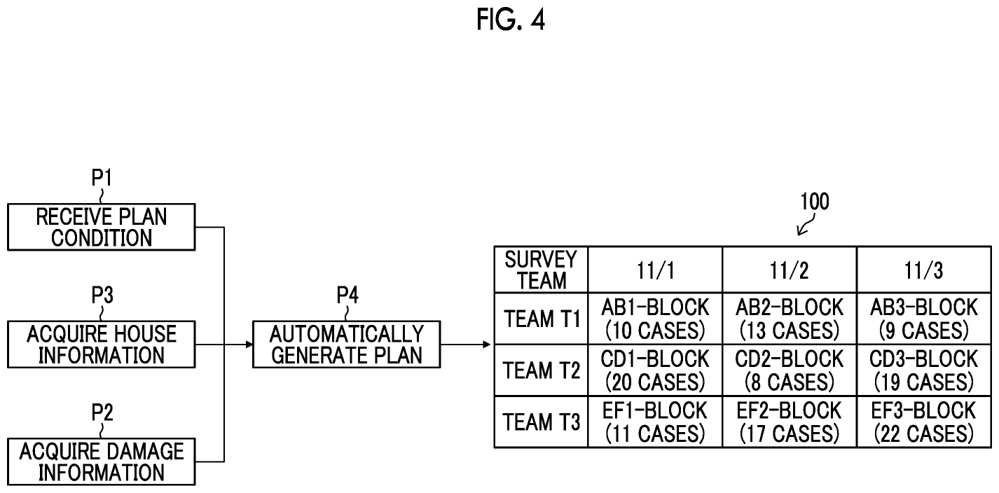

FIG. 3 is a flowchart showing each step of a survey plan generation method according to a first embodiment using the survey plan generation apparatus 10. FIG. 4 is a process diagram of each step of the survey plan generation method. The survey plan generation method is implemented by the processor 12 executing the survey plan generation program stored in the memory 14. The survey plan generation program may be provided by a computer-readable non-transitory recording medium. In this case, the survey plan generation apparatus 10 may read the survey plan generation program from the non-transitory recording medium, and store the survey plan generation program in the memory 14.

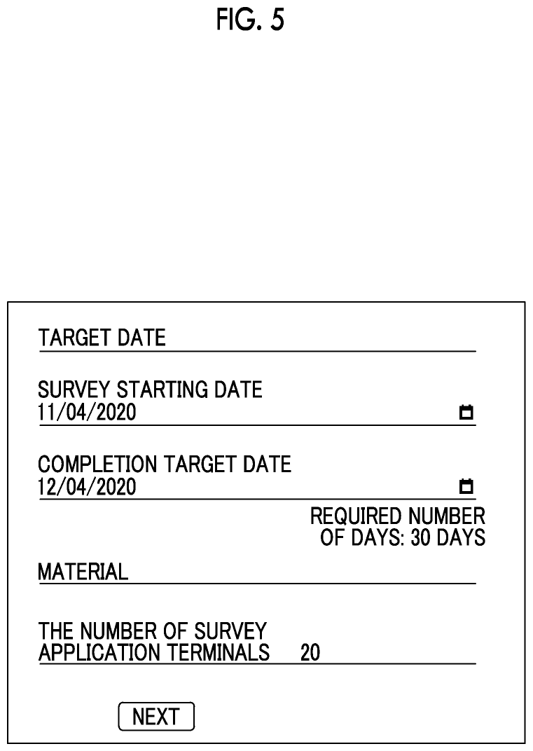

In step S1 (an example of a “condition acquisition step”), the plan condition input reception unit 22 receives the input of the plan condition to be satisfied by the generated survey plan (process P1). FIG. 5 is an example of an input screen displayed on the display 20. FIG. 5 shows an example in which a target date and a material are input as the plan conditions.

The target date includes a survey starting date and a completion target date. In a case in which the survey starting date and the completion target date are input, a required number of days is decided. In the example shown in FIG. 5, since the survey starting date is input as Nov. 4, 2020 and the completion target date is input as Dec. 4, 2020, the required number of days is 30 days. The automatic plan generation unit 28 generates the survey plan to fall within the input survey starting date and completion target date as much as possible.

The material is the number of materials essential for the survey, and is the number of survey application terminals here. The number of materials affects an upper limit of the number of survey teams and is a constraint on the number of areas that can be surveyed.

Returning to the description of FIG. 3 and FIG. 4, in step S2, the damage information acquisition unit 24 acquires the damage information including a degree of damage, an address, and the like in the area that is the target of the damage certification survey (process P2).

The damage information is, for example, a detection result of the disaster house obtained by inputting a high-altitude image captured by using a drone or the like to a damage determination artificial intelligence (AI), and an automatic determination result of the degree of damage. The damage information may be disaster building information manually input in a case of finding the disaster house by a patrol by a staff of a local government immediately after the disaster. The damage information may be information that automatically incorporates a result of the progress of the damage certification survey.

In addition, in step S3, the house information acquisition unit 26 acquires the house information that is the target of the damage certification survey (process P3).

In step S4 (an example of a “survey plan generation step”), the automatic plan generation unit 28 generates the plurality of survey plan candidates for each optimization criterion that is trade-off based on the information on the plan condition received by the plan condition input reception unit 22, the damage information acquired by the damage information acquisition unit 24, and the survey target house information acquired by the house information acquisition unit 26 (process P4). Here, the automatic plan generation unit 28 generates three survey plan candidates which are a survey plan in a case in which a priority is given to the area in which the damage is large, a survey plan in a case in which a priority is given to the area in which the damage is small, and a survey plan in a case in which the number of survey days is minimized.

FIG. 4 shows an example of a survey plan candidate 100. The survey plan candidate 100 includes the survey schedule, the survey target house list per day, and the allocation information for each survey team. The allocation information for each survey team includes information on an area allocated to the survey team or a house allocated to the survey team. In the example shown in FIG. 4, 10 cases of AB1-block (10 houses) on November 1, 13 cases of AB2-block on November 2, and 9 cases of AB3-block on November 3 are allocated to a team T1.

Returning to the description of FIG. 3, in step S5, the plan candidate display unit 30 displays, in a selectable manner, the summary information on each of the plurality of survey plan candidates generated by the automatic plan generation unit 28 on the display 20. The displayed summary information on the plan candidate is expressed as a set of indicators for comparing the plan candidates, such as the total number of survey days and the prediction of the number of persons per each week.

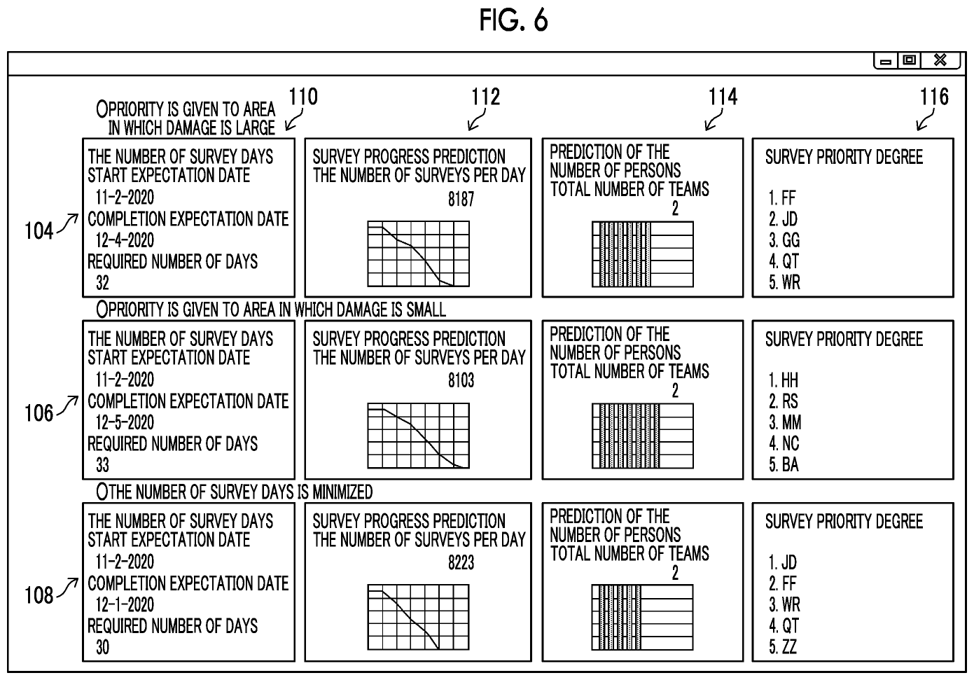

FIG. 6 is an example of a plan candidate selection screen displayed by the plan candidate display unit 30 on the display 20. In the example shown in FIG. 6, a first plan candidate 104, a second plan candidate 106, and a third plan candidate 108 are displayed on the plan candidate selection screen in a selectable manner.

The first plan candidate 104 is the survey plan generated with the priority given to the area in which the damage is large. The second plan candidate 106 is the survey plan generated with the priority given to the area in which the damage is small. The third plan candidate 108 is the survey plan generated by minimizing the number of survey days.

The plan candidate selection screen includes an indicator for determining a quality of each plan candidate as the summary information on each plan candidate. Here, as the indicators, required-number-of-survey-days information 110, survey progress prediction information 112 for each week, required-number-of-surveyors (number-of-survey-teams) prediction information 114 for each week, and order information 116 of the area to be surveyed are displayed.

The required-number-of-survey-days information 110 includes a survey start expectation date, a survey completion expectation date, and a required number of days from the start of the survey to the completion of the survey. The survey progress prediction information 112 for each week includes a broken line graph showing the number of surveys per day and the number of remaining surveys in a case in which the survey is performed according to the survey plan. The number of surveys per day is a value obtained by dividing a total number of surveys by the required number of days. The required-number-of-surveyors (number-of-survey-teams) prediction information 114 for each week includes a total number of survey teams and a bar graph showing the number of survey teams for each week.

Returning to the description of FIG. 3, in step S6, the plan candidate selection reception unit 32 receives the selection of any survey plan candidate of the plurality of survey plan candidates. The user selects one desired survey plan candidate from among the plurality of survey plan candidates by using the input interface 18. Here, the first plan candidate 104 is selected by the user. The plan candidate selection reception unit 32 receives the first plan candidate 104 as the survey plan to be adopted.

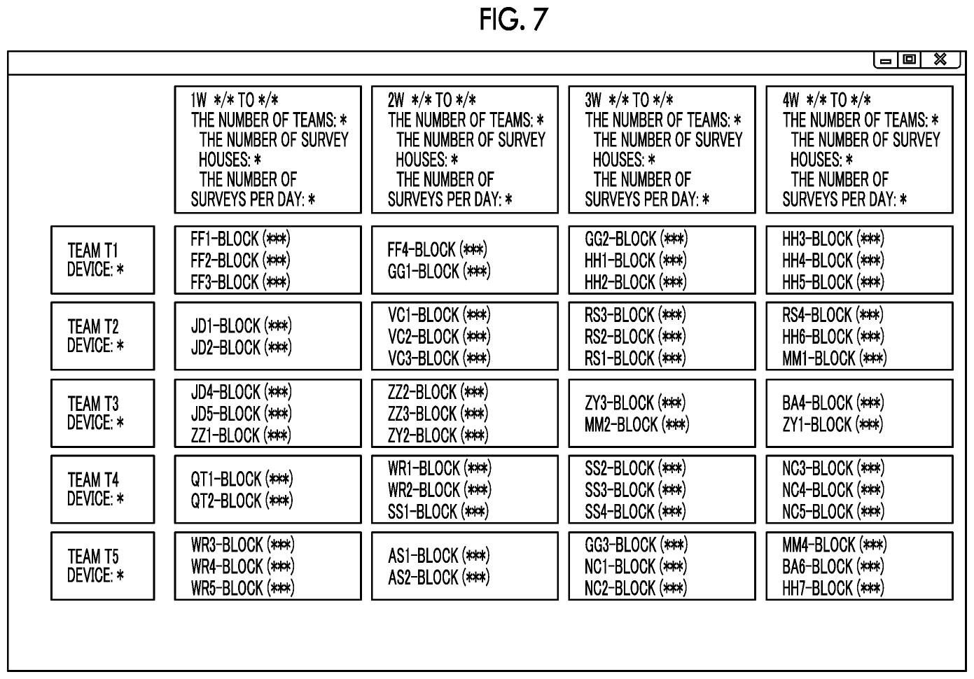

In step S7, the plan edition means display unit 36 displays the survey plan received by the plan candidate selection reception unit 32 on the display 20 in an editable manner. FIG. 7 is an example of an edition screen displayed on the display 20. Here, the survey schedule table including the allocation areas of the team T1, a team T2, a team T3, a team T4, and a team T5 for each week is displayed.

In addition, in step S8, the plan edition operation reception unit 38 receives the edition operation by the input interface 18 of the survey plan displayed by the plan edition means display unit 36 on the display 20. As a result, it is possible for the user to manually edit the survey plan.

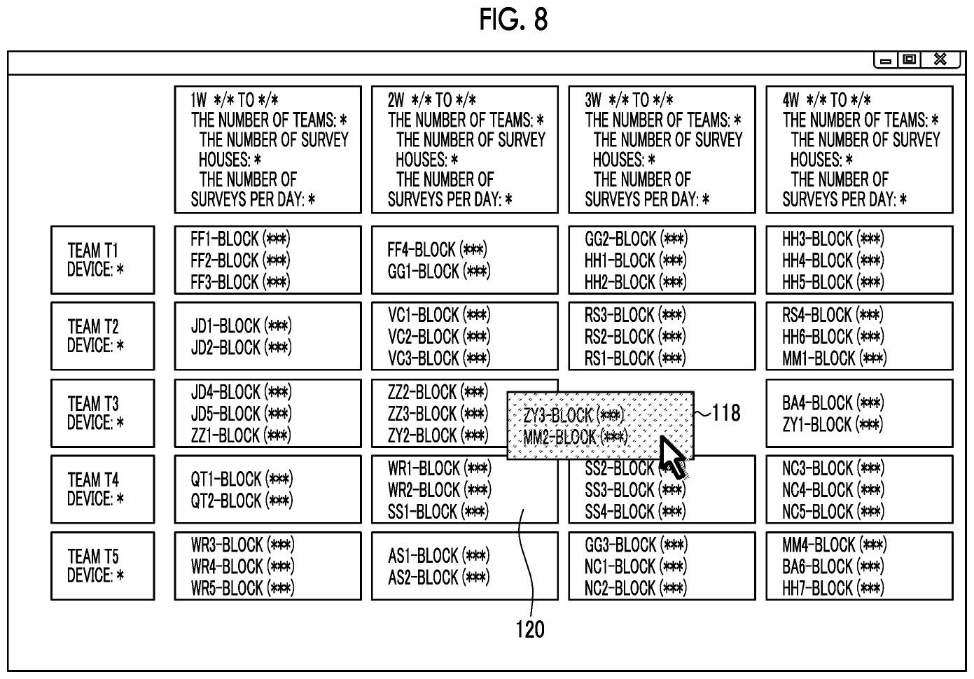

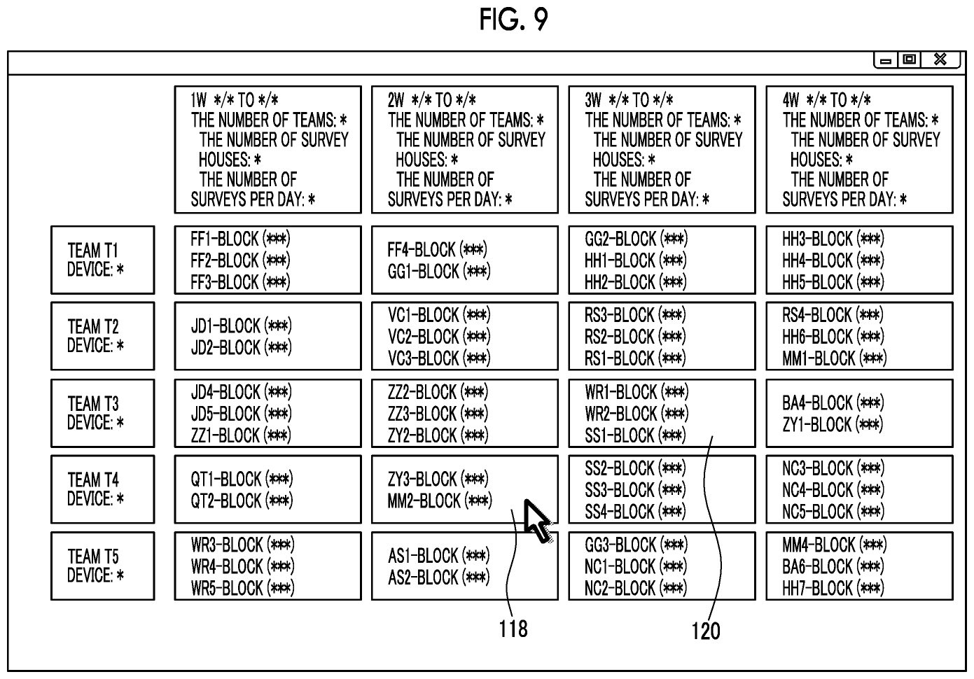

FIG. 8 and FIG. 9 are diagrams showing examples in which the allocation area of a third week of the team T3 and the allocation area of a second week of the team T4 are changed (exchanged) on the edition screen shown in FIG. 7. FIG. 8 shows a state in which a cell 118 showing the allocation area of the third week of the team T3 is moved by the drag operation by using the pointing device (not shown). In addition, FIG. 9 shows a state in which the cell 118 is subjected to the drop operation to a position of a cell 120 showing the allocation area of the second week of the team T4. As shown in FIG. 9, in a case in which the cell 118 is subjected to the drop operation to the position of the cell 120, the cell 118 is arranged at the position at which the cell 120 has been located, and simultaneously the cell 120 is moved and arranged at the position at which the cell 118 has been located. That is, the allocation area of the third week of the team T3 and the allocation area of the second week of the team T4 are exchanged.

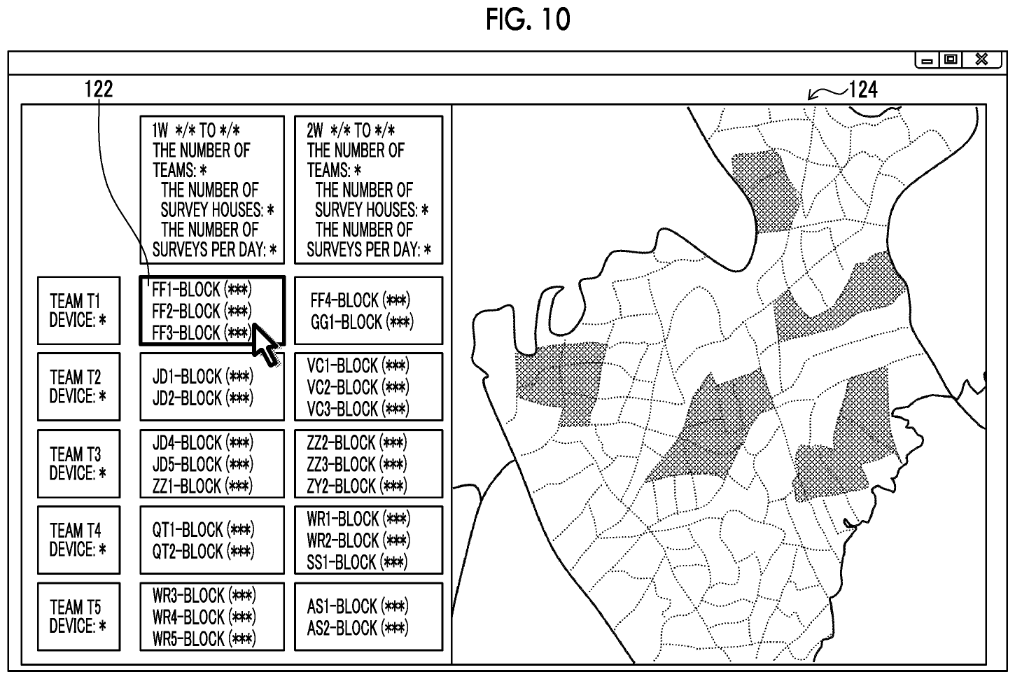

It should be noted that the plan edition means display unit 36 can display the map acquired by the map information acquisition unit 34 on the display 20 together with the survey plan. FIG. 10 is an example of the edition screen on which the survey plan and the map are simultaneously displayed on the display 20. The user can display the map of the area related to the survey plan by performing a selection operation of the cell of the survey plan by using the pointing device (not shown). Here, an example is shown in which a map 124 is displayed as a result of the selection operation of the cell 122 showing the allocation area of the first week of the team T1 by the user. The map 124 is a map including the area displayed in the cell 122, and the area shown by the cell 122 is highlighted.

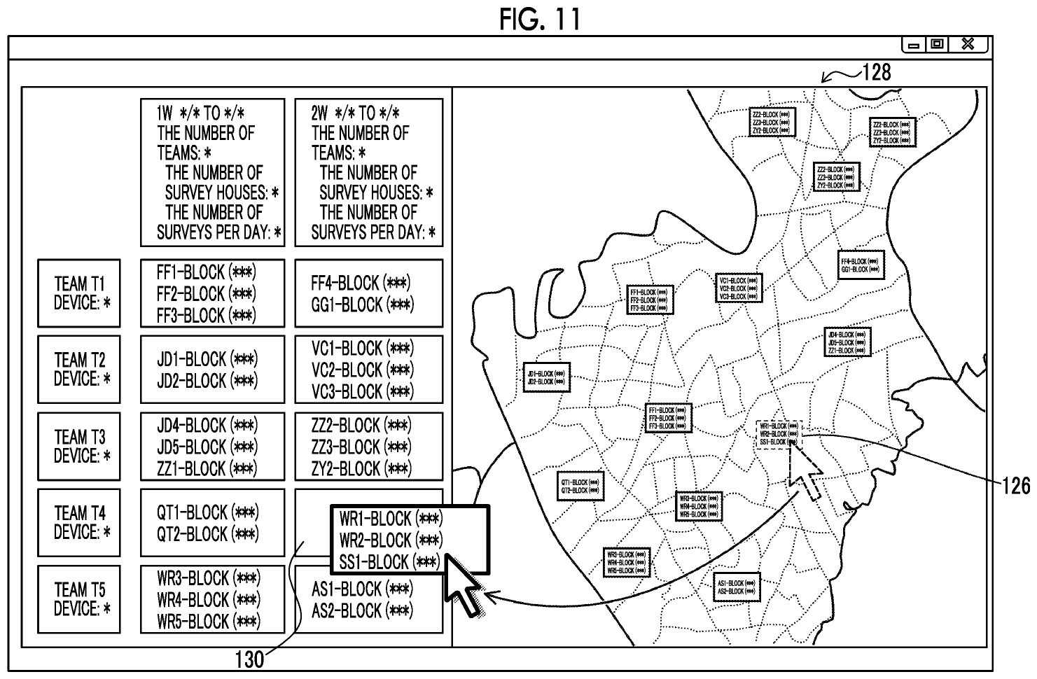

In addition, FIG. 11 is another example of the edition screen on which the survey plan and the map are displayed simultaneously on the display 20. In the generated survey plan, all the areas that are required to be surveyed are allocated to any of the survey teams, but the user can perform an operation of manually releasing the allocation after the allocation. In the example shown in FIG. 11, a map 128 including an unallocated area 126 that is not allocated to any team by the operation of releasing the allocation is displayed. Here, an example will be described in which the unallocated area 126 in which the user releases the allocation is reallocated. The user can allocate the desired area to the survey team and the schedule shown by the cell by performing the drag-and-drop operation of the desired area of the map 128 to a position of a desired cell by using the pointing device (not shown). Here, a state is shown in which the unallocated area 126 is edited to the allocation area of the survey of the second week of the team T4 by performing the drag-and-drop operation of the unallocated area 126 to the cell 130 of the second week of the team T4.

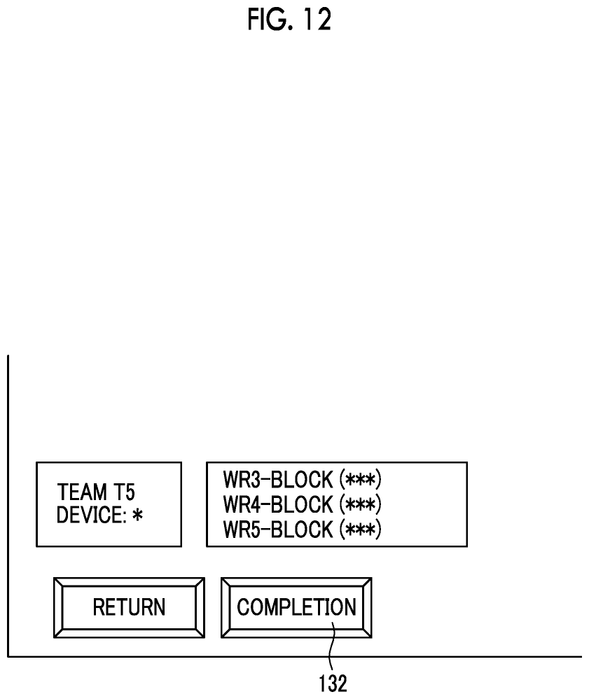

In addition, a completion button 132 for terminating the edition operation of the survey plan is displayed on the display 20. FIG. 12 is an example of the edition screen of the display 20 on which the completion button 132 is displayed. In a case in which the user operates the completion button 132 by using the input interface 18, the survey plan is fixed, and the processing of the present flowchart is terminated.

As described above, with the survey plan generation apparatus 10, the survey plan can be automatically generated according to the plan condition. In addition, with the survey plan generation apparatus 10, the plurality of survey plan candidates are generated according to the plurality of optimization criteria, and the summary information on the plurality of survey plan candidates is displayed in a selectable manner, so that it is possible for the user to select the desired survey plan candidate according to the optimization criteria from among the plurality of survey plan candidates. Further, with the survey plan generation apparatus 10, the selected survey plan can be edited, so that the user can acquire the optimum survey plan.

### Second Embodiment

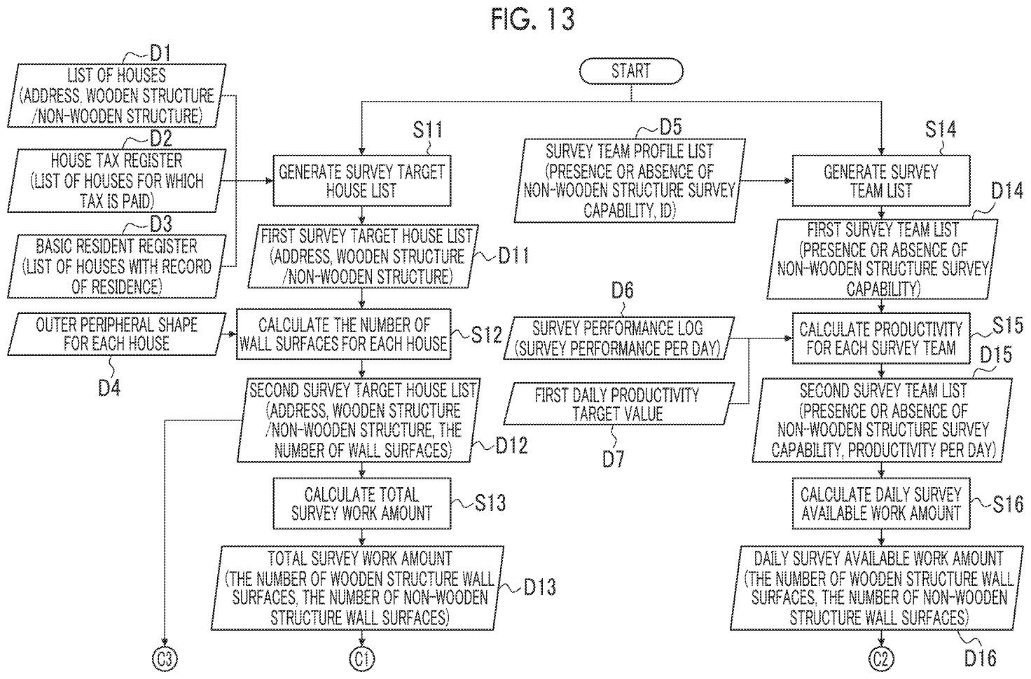

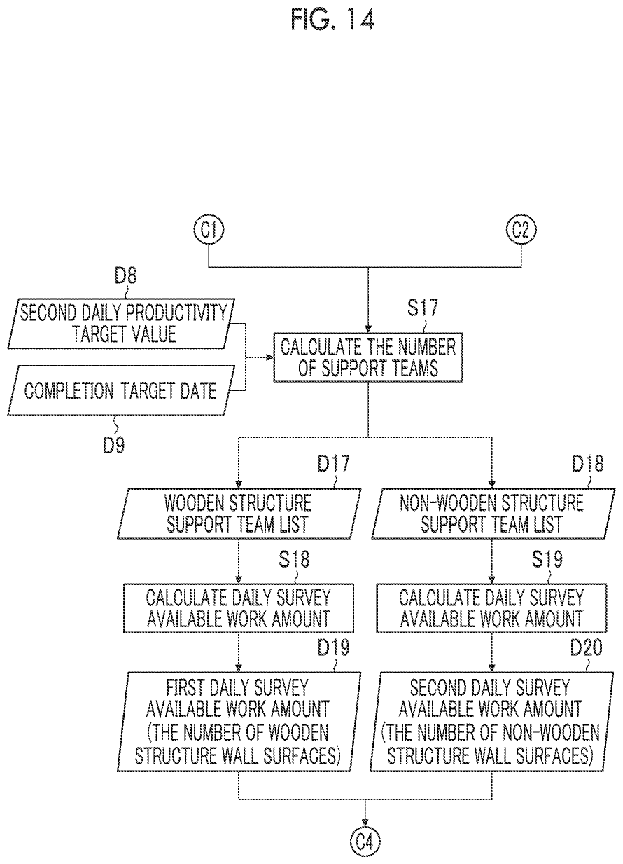

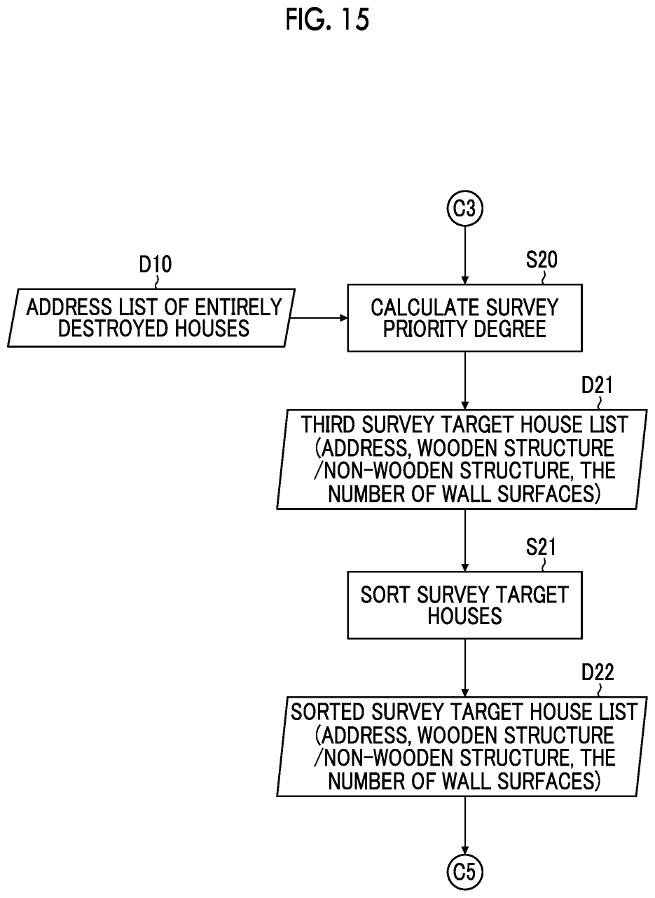

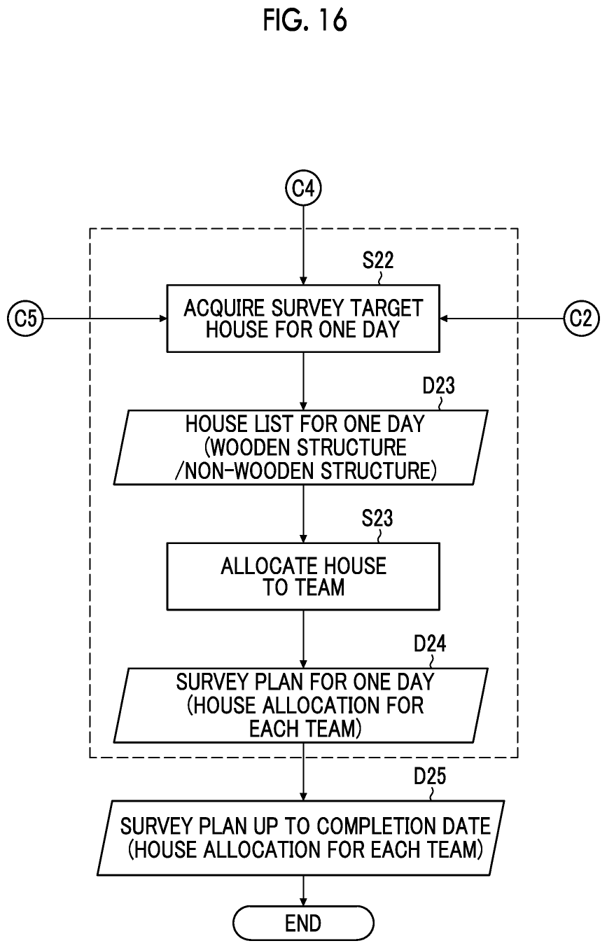

FIGS. 13 to 16 are flowcharts showing each step of a survey plan generation method according to a second embodiment using the survey plan generation apparatus 10. It should be noted that a terminal C1 of FIG. 13 is connected to the terminal C1 of FIG. 14, a terminal C2 of FIG. 13 is connected to the terminal C2 of FIG. 14 and the terminal C2 of FIG. 16, a terminal C3 of FIG. 13 is connected to the terminal C3 of FIG. 15, a terminal C4 of FIG. 14 is connected to the terminal C4 of FIG. 16, and a terminal C5 of FIG. 15 is connected to the terminal C5 of FIG. 16.

Data D1 to D10 of FIGS. 13 to 16 are data to be input to the survey plan generation apparatus 10. The survey plan generation apparatus 10 acquires the data D5 and D7 to D9 from the memory 14, and acquires the data D1 to D4, D6, and D10 via the communication interface 16 or the input interface 18. Data D11 to D25 are data generated by the survey plan generation apparatus 10.

The pieces of processing of steps S11 to S13 shown in FIG. 13 are processing of calculating the total survey work amount of the damage certification survey. In step S11, the processor 12 generates a first survey target house list (data D11) based on a list of the houses (data D1), a house tax register (data D2), and a basic resident register (data D3).

The list of the houses includes information on a position and an address of the house and the distinction between the wooden structure and the non-wooden structure. The position of the house includes latitude/longitude information on the house. The house tax register includes information on the list of the houses for which house tax is paid. The basic resident register includes information on the list of the houses with a record of residence. In addition, the first survey target house list includes the information on the address of each house and the distinction between the wooden structure and the non-wooden structure. The survey target house is obtained by excluding a house for which the house tax is not paid and a house that is not described in the basic resident register from all the houses in the local government that performs the damage certification survey.

Next, in step S12, the processor 12 calculates the number of wall surfaces for each house based on the first survey target house list (data D11) and the outer peripheral shape (data D4) for each house, and generates a second survey target house list (data D12). The second survey target house list includes the information on the address of each house, the distinction between the wooden structure and the non-wooden structure, and the number of wall surfaces.

The outer peripheral shape for each house is, for example, outer peripheral shape data (two-dimensional polygon data) of the house published by the Geospatial Information Authority of Japan. The number of wall surfaces for each house can be calculated by the following expression 1.

(Number of wall surfaces)=(Number of vertices of house)−1 (Expression 1)

The two-dimensional polygon data constituting the outer periphery (wall surface) of the house has a “closed” vertex configuration, and always includes the same value as the first element of the list as the last element of a vertex list of a certain house. For example, in a case in which the coordinates of the four vertices of the house having four wall surfaces are (0,0), (1,0), (1,1), and (0,1), the vertex list of the two-dimensional polygon data has five elements of (0,0), (1,0), (1,1), (0,1), and (0,0), and is configured so that the line is closed in a case in which the value of the start point enters the end. Therefore, the number of wall surfaces of the house is acquired by subtracting 1 from the number of vertices of the two-dimensional polygon data. It should be noted that a value in which the distance between the vertices constituting the wall surface is 1 meter or less is excluded.

Further, in step S13, the processor 12 calculates the total survey work amount (data D13) based on the second survey target house list (data D12). The total survey work amount is the total number of wall surfaces of all the houses and has a relationship of the following expression 2.

(Total survey work amount)=(Total number of wall surfaces for each house) (Expression 2)

It should be noted that the total survey work amount is expressed by the number of wall surfaces because the damage certification survey is performed in a unit of the wall. The processor 12 calculates the total survey work amount for each of the wooden structure and the non-wooden structure. The total survey work amount includes information on the number of wall surfaces of the house of the wooden structure and the number of wall surfaces of the house of the non-wooden structure.

In addition, the processor 12 performs the pieces of processing of steps S14 to S16 in parallel with the pieces of processing of steps S11 to S13. The pieces of processing of steps S14 to S16 are processing of calculating a daily survey available work amount of the survey team of a host government office based on the productivity of the survey team of the host government office. The survey team of the host government office refers to a survey team organized by the surveyors belonging to the local government that performs the damage certification survey.

In step S14, the processor 12 generates a first survey team list (data D14) based on a survey team profile list (data D5). The survey team profile list includes information on a flag indicating whether or not the house of the non-wooden structure can be surveyed for each surveyor of each survey team of the host government office, and a surveyor identification (ID). The first survey team list (data D14) includes information on the presence or absence of non-wooden structure survey capability for each survey team. In a case in which any one of the surveyors constituting the survey team is an expert that can perform the non-wooden structure survey, the survey team has the non-wooden structure survey capability.

In step S15 (an example of a “condition acquisition step”), the processor 12 calculates the productivity for each survey team based on at least one of the first survey team list (data D14), a survey performance log (data D6), or a first daily productivity target value (data D7), and generates a second survey team list (data D15). The survey performance log is the number of surveys per day for each survey team, and for example, an average of the performance values of the number of wall surfaces surveyed in the past three days can be used. In a case in which the survey performance log is not present, the first daily productivity target value of the survey team input by the user is used as a default value. The processor 12 calculates the productivity of each survey team for each of the wooden structure and the non-wooden structure. The second survey team list includes information on the presence or absence of non-wooden structure survey capability for each survey team, and the productivity per day.

In step S16, the processor 12 calculates the daily survey available work amount for each the survey team based on the second survey team list (data D15), and generates a daily survey available work amount (data D16). The processor 12 calculates the daily survey available work amount for each survey team for each of the wooden structure and the non-wooden structure. The daily survey available work amount (data D16) includes the total productivity of each survey team per day.

The pieces of processing of steps S17 to S19 shown in FIG. 14 are processing of calculating the daily survey available work amount of a support team that performs the survey that cannot be handled by the survey team of the host government office. The support team refers to a team organized by assistance surveyors other than the surveyors of the host government office, and is organized by, for example, assistance surveyors dispatched in response to a support request to another local government.

As shown in FIG. 14, in step S17, the processor 12 calculates the number of wooden structure support teams and the number of non-wooden structure support teams based on the total survey work amount (data D13), the daily survey available work amount (data D16) of the survey team of the host government office, a second daily productivity target value (data D8) of the support team, and the completion target date (data D9), and generates a wooden structure support team list (data D17) and a non-wooden structure support team list (data D18).

The number of wooden structure support teams is calculated by the following expression 3.

(Number of wooden structure support teams)=(Total number of wooden structure wall surfaces−(Number of wooden structure wall surfaces that can be surveyed by survey team of the host government office per day×Target number of days))/(Second daily productivity target value×Target number of days) (Expression 3)

Similarly, the number of non-wooden structure support teams is calculated by the following expression 4.

(Number of non-wooden structure support teams)=(Total number of non-wooden structure wall surfaces−(Number of non-wooden structure wall surfaces that can be surveyed by survey team of the host government office per day×Target number of days))/(Second daily productivity target value×Target number of days) (Expression 4)

In a case in which the survey performance log of the support team is present, the survey performance log of the support team may be used instead of the second daily productivity target value. In addition, the target number of days is the number of days from the survey starting date to the completion target date.

In step S18, the processor 12 calculates the daily survey available work amount of the wooden structure support team based on the wooden structure support team list (data D17), and generates a first daily survey available work amount (data D19). The first daily survey available work amount (data D19) includes information on the number of wooden structure wall surfaces.

Similarly, in step S19, the processor 12 calculates the daily survey available work amount of the non-wooden structure support team based on the non-wooden structure support team list (data D18), and generates a second daily survey available work amount (data D20). The second daily survey available work amount (data D20) includes information on the number of non-wooden structure wall surfaces.

The pieces of processing of steps S20 to S22 shown in FIG. 15 are processing of sorting the survey target houses according to a survey priority degree. As shown in FIG. 15, in step S20, the processor 12 calculates the survey priority degree based on the second survey target house list (data D12) and an address list of the entirely destroyed houses (data D10), and generates a third survey target house list (data D21). The third survey target house list includes the information on the address of the entirely destroyed house, the distinction between the wooden structure and the non-wooden structure, and the number of wall surfaces.

In the calculation of the survey priority degree, for example, in a case of “priority is given to the area in which the damage is large”, a “ratio of entirely destroyed house” in the block to which the house belongs is used as the priority degree. That is, the survey priority degree in this case can be expressed by the following expression 5. As for the survey priority degree, the priority degree is higher as the value of the block is larger.

(Survey priority degree)=(Number of entirely destroyed houses in block)/(Number of all houses in block) (Expression 5)

It should be noted that the number of entirely destroyed houses in the block can be extracted from the address list of the entirely destroyed houses in the damage information acquired by the damage information acquisition unit 24.

On the other hand, in a case of “priority is given to the area in which the damage is small”, a value obtained by multiplying the “ratio of entirely destroyed house” in the block to which the house belongs by −1 is used as the priority degree. That is, the survey priority degree in this case can be expressed by the following expression 6.

(Survey priority degree)=−(Number of entirely destroyed houses in block)/(Number of all houses in block) (Expression 6)

Further, in step S21, the processor 12 sorts the survey target houses in an order of the survey priority degree based on the third survey target house list (data D21), and generates a sorted survey target house list (data D22). Here, the processor 12 sorts the third survey target house list in descending order of the survey priority degree of the houses, and further sorts the houses in the same block in the order of the district number. By performing sorting in this way, houses that are close to each other in the post-processing are allocated to the same survey team, and the efficiency of the survey can be improved.

The pieces of processing of steps S22 to S23 shown in FIG. 16 are processing of allocating the survey target house to the survey team or the support team. Here, the survey team of the host government office and the support team are not particularly distinguished from each other, and are simply referred to as the survey team.

As shown in FIG. 16, in step S22, the processor 12 acquires the survey target houses for one day based on the daily survey available work amount (data D16), the first daily survey available work amount (data D19), the second daily survey available work amount (data D20), and the sorted survey target house list (data D22), and generates the house list for one day (data D23). The house list for one day (data D23) includes information on the distinction between the wooden structure and the non-wooden structure.

In step S23, the processor 12 allocates the house to each survey team based on the house list for one day (data D23), and generates a survey plan for one day (data D24). The survey plan for one day (data D24) includes information on the house allocation for each survey team. Here, the processor 12 allocates the house to each survey team by a bin packing algorithm. The processor 12 allocates the non-wooden structure house only to the survey team that can survey the non-wooden structure house. The processor 12 preferentially allocates the wooden structure house to the survey team that cannot survey the non-wooden structure house, and allocates the wooden structure house, which is not allocated, to the survey team that can survey the non-wooden structure house.

The processor 12 repeats the pieces of processing of steps S22 and S23 until the last house described in the sorted survey target house list (data D22) is allocated to any of the survey teams, and generates a survey plan up to the completion date (data D25). The survey plan up to the completion date (data D25) includes information on the house allocation for each survey team up to the completion date.

As described above, with the survey plan generation apparatus 10, it is possible to automatically generate the survey plan according to the productivity of the surveyor or the survey team.

It should be noted that the survey plan generation apparatus 10 may recalculate the productivity of the plurality of surveyors or the productivity of the plurality of survey teams based on the survey performances of the plurality of surveyors in a certain period in the survey performed based on the generated survey plan or the survey performances of the plurality of survey teams in a certain period (an example of a “recalculation step”), and may update the survey plan based on the recalculated productivity (an example of a “survey plan update step”). Although it is difficult to manually perform such an update of the survey plan, the survey plan generation apparatus 10 can automatically generate the survey plan after the update.

In a case of support from another local government in a case in which a large-scale disaster occurs, it is not realistic to uniformly measure the productivity from the viewpoint of the efficiency, the skill, and the like in advance from the viewpoint of urgency and the viewpoint of a difference in criteria. For this reason, it is realistic to measure the productivity while actually performing the work and reflect the productivity in the work from the next day onward. By generating the survey plan by using the productivity that is updated based on the daily survey performance, it is possible to generate a plan with high accuracy even in a case of a trade-off calculation between the number of days and the number of persons (or the amount of money).

The surveyor of each survey team inputs a survey result to the survey application terminal (not shown) each time the survey is terminated. Therefore, the survey plan generation apparatus 10 can recalculate the productivity per day of each survey team by acquiring the survey result for one day (an example of a certain period) as the survey performance log (data D6), and can update the survey plan based on the recalculated productivity. The recalculation of the productivity may be performed in consideration of the productivity used so far, or may be performed from the actual performance for one day input without considering the productivity so far.

In a situation in which the disaster certificate is issued earlier by completing the survey earlier and the disaster relief costs from the local government can be obtained earlier, it is conceivable that the survey team performs the survey the next day ahead of plan. In addition, there is a case in which the survey may not progress as planned due to circumstances. By acquiring these cases as the survey performance log, it is possible to appropriately calculate the productivity per day of each survey team.

It should be noted that, in a case in which the survey does not progress as planned, it is preferable to isolate whether it is a problem of the capability of the surveyor of the survey team or a problem of an external factor other than the capability. For example, in a case in which the external factor that affects the entire survey team occurs, such as a case in which the survey cannot be performed due to bad weather, it may not be reflected in the recalculation of the productivity. In addition, even in a case in which a specific survey team has a special external factor, it is possible not to affect the estimation of the productivity by inputting the fact together with the survey result.

In addition, in a case in which the survey does not progress as planned, it may be determined that a part of the problem is the capability of the surveyor and the other part is a problem of the external factor. For example, in a case in which the progress rates of the surveys of the teams T1, T2, and T3 are 80%, 60%, and 50%, respectively, as compared to the previous day, it can be determined that the decrease in the team T2, which is the median value, is the contribution of the external factor that affects all the survey teams. In this case, since the 40% decrease is the external factor, it can be determined that the team T1 has a 20% increase due to the capability and the team T3 has a 10% decrease due to the capability.

In addition, the update of the survey plan due to the recalculation of the productivity may be performed every half day instead of every day. By generating the survey plan for one day and updating the survey plan for the remaining half day (afternoon) based on the survey performance (an example of survey performances for a certain period) for the half day (morning), the survey plan based on finer productivity can be generated.

It should be noted that, in a case in which the survey plan is updated, it is preferable that the survey plan generation apparatus 10 regenerates the plurality of survey plan candidates according to the plurality of optimization criteria and displays the plurality of survey plan candidates in a selectable manner again. The reason is that it is conceivable that, in a case in which a large-scale disaster occurs, what should be given the highest priority is changed depending on the demand on the residents, changes in the resources that the government can provide, and the like, and the optimization criteria may also be changed each time. It should be noted that, in a case in which the survey plan is updated, the survey plan generation apparatus 10 may generate the survey plan according to the optimization criteria selected last time.

In addition, in a case in which the survey plan is updated, the survey plan generation apparatus 10 may reorganize the surveyors of each survey team.

### Third Embodiment

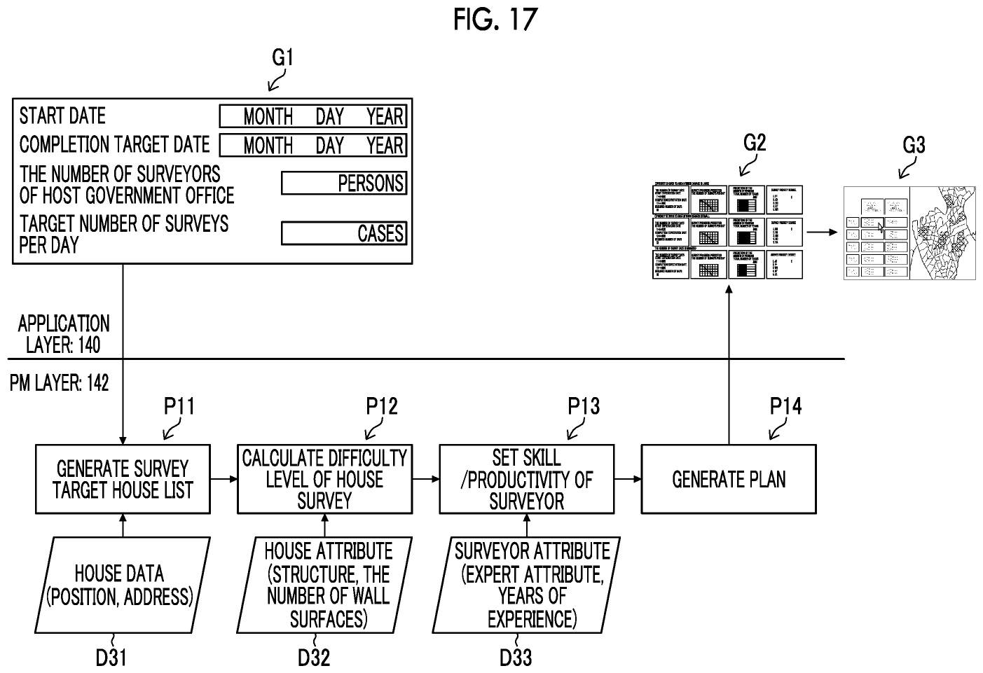

FIG. 17 is a process diagram showing a survey plan generation method according to a third embodiment using the survey plan generation apparatus 10. In FIG. 17, an application layer 140 and a process mining (PM) layer 142 are shown separately. The application layer 140 is a program that controls a user interface that displays the reception of the input from the user and displays the generated survey plan information. On the other hand, the PM layer 142 is an algorithm unit that generates the survey plan based on the data input from the application layer 140 and the data stored in a database or the like.

The processor 12 displays a condition input form G1 on the display 20 in the application layer 140. Here, the condition input form G1 is a screen for allowing the user to input a start target date, a completion target date, the number of surveyors of the host government office, and a target number of surveys per day.

After the input in the condition input form G1 is terminated, the processor 12 generates the survey target house list in the PM layer 142 based on the house data (data D31) (process P11). The house data includes the information on the position of the house and the address.

Next, the processor 12 calculates a difficulty level of the house survey based on a house attribute (data D32) (process P12). The house attribute includes information on the structure of the house and the number of wall surfaces.

In addition, the processor 12 sets a skill and the productivity of the surveyor based on a surveyor attribute (data D33) (process P13). The surveyor attribute includes information on an expert attribute and years of experience of each surveyor. The expert attribute includes the presence or absence of expertise in architecture.

Then, the processor 12 generates the survey plan candidate (process P14). The processor 12 displays a plan summary display G2, which is a summary of the generated plurality of survey plan candidates, on the display 20 in the application layer 140.

In a case in which one survey plan is selected by the user in the plan summary display G2, the processor 12 displays a plan editor G3 for editing the selected survey plan on the display 20.

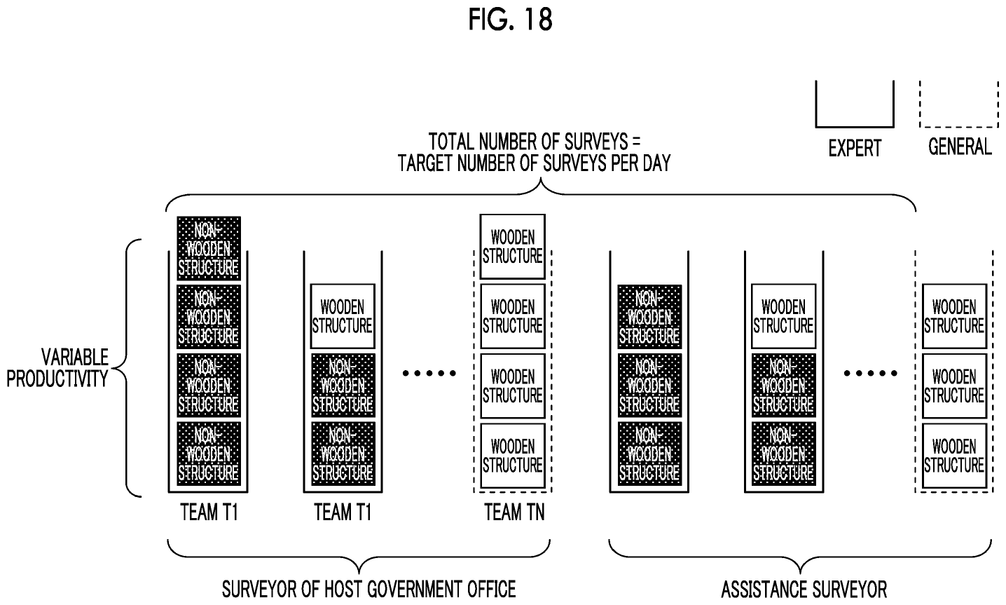

FIG. 18 is a diagram showing generation of the survey plan candidate in the process P14. Here, an example will be described in which skill-based bin packing is used.

In FIG. 18, one rectangle indicates one surveyor. The surveyor described as “non-wooden structure” is an expert surveyor that can perform the non-wooden structure survey, and the surveyor described as “wooden structure” is a general surveyor that can perform only the wooden structure survey.

In addition, in FIG. 18, a U-shaped box indicates one survey team. A solid box indicates an expert survey team, and a broken box indicates a general survey team. Here, the teams T1, T2, . . . , and TN are constituted by the surveyors of the host government office, and the other survey teams are organized by the assistance surveyors.

The team T1 is constituted by four non-wooden structure surveyors, and is the expert survey team. In addition, the team T2 is constituted by two non-wooden structure surveyors and one wooden structure surveyor, and is the expert survey team. On the other hand, the team TN is constituted by four wooden structure surveyors, and is the general survey team.

Each survey team has variable productivity, and a number of surveys according to each productivity are allocated. In addition, the surveys are allocated to each survey team such that the total number of surveys allocated to all survey teams is the target number of surveys per day.

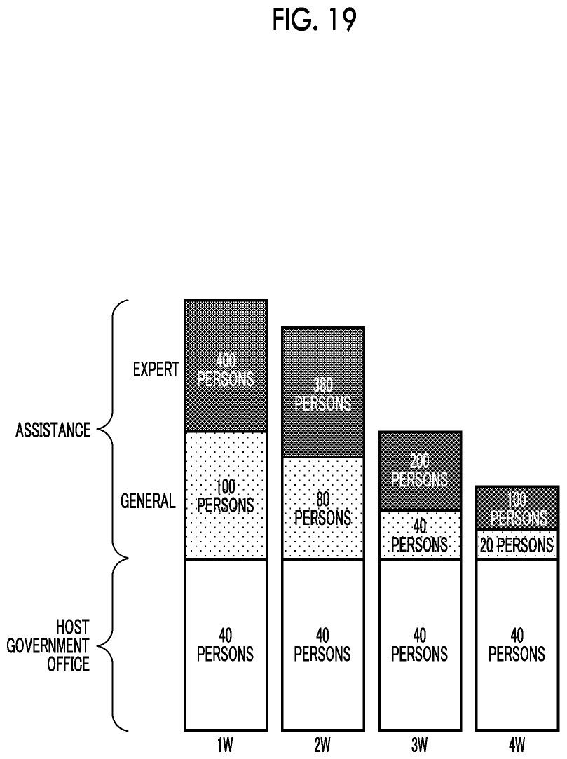

FIG. 19 is a diagram showing a part of the plan summary display G2. Here, the number of surveyors for each week is displayed in a manner that the surveyors of the host government office and the assistance surveyors are distinguished from each other. In addition, the assistance surveyors are displayed in a manner that the expert surveyors and the general surveyors are distinguished from each other. For example, it can be known that, in the first week, the surveyors of the host government office are 40 persons, the expert surveyors of the assistance surveyors are 400 persons, and the general surveyors of the assistance surveyors are 100 persons.

In this way, by displaying the number of surveyors for each week for each of the plurality of survey plan candidates, the user can compare the plan candidates with each other.

[Others]

The technical scope of the present invention is not limited to the range described in the above-described embodiments. The configurations and the like in each embodiment can be appropriately combined between the respective embodiments without departing from the gist of the present invention.

### EXPLANATION OF REFERENCES

10: survey plan generation apparatus
12: processor
14: memory
16: communication interface
18: input interface
20: display
22: plan condition input reception unit
24: damage information acquisition unit
26: house information acquisition unit
28: automatic plan generation unit
30: plan candidate display unit
32: plan candidate selection reception unit
34: map information acquisition unit
36: plan edition means display unit
38: plan edition operation reception unit
100: survey plan candidate
104: first plan candidate
106: second plan candidate
108: third plan candidate
110: required-number-of-survey-days information
112: survey progress prediction information
114: required-number-of-surveyors (number-of-survey-teams) prediction information
116: order information
118: cell
120: cell
122: cell
124: map
126: unallocated area
128: map
130: cell
132: completion button
140: application layer
142: PM layer
C1 to C5: terminal
D1 to D25, D31 to D33: data
G1: condition input form
G2: plan summary display
G3: plan editor
P1 to P4, P11 to P14: process
T1 to T5, TN: team
S1 to S8, S11 to S30: each step of survey plan generation method

What is claimed is:

1. A survey plan generation apparatus that generates a survey plan for surveying a plurality of buildings by a plurality of surveyors, the apparatus comprising:
at least one processor; and
at least one memory that stores a command to be executed by the at least one processor,
wherein the at least one processor
acquires a condition which is to be satisfied by the survey plan and includes productivity of the plurality of surveyors or productivity of a plurality of survey teams organized by allocating the plurality of surveyors, respectively,
generates the survey plan based on the acquired condition,
recalculates the productivity of the plurality of surveyors or the productivity of the plurality of survey teams based on survey performances of the plurality of surveyors in a certain period in a survey performed based on the generated survey plan or survey performances of the plurality of survey teams in a certain period, and
updates the survey plan based on the recalculated productivity.

2. The survey plan generation apparatus according to claim 1,
wherein the at least one processor
generates a plurality of survey plan candidates,
displays summary information on the generated plurality of survey plan candidates on a display, and
receives selection of the survey plan candidate to be adopted as the survey plan from among the displayed plurality of survey plan candidates by a user.

3. The survey plan generation apparatus according to claim 2,
wherein the summary information on the survey plan candidates includes at least one indicator of a total number of survey days or prediction of the number of persons for each of certain periods.

4. The survey plan generation apparatus according to claim 2,
wherein the at least one processor generates the plurality of survey plan candidates according to a plurality of optimization criteria.

5. The survey plan generation apparatus according to claim 4,
wherein the survey includes a survey of damage to a plurality of buildings, and
the optimization criteria include at least one of a priority to an area in which the damage to the building is large, a priority to an area in which the damage to the building is small, a smallest number of days, or a smallest number of persons.

6. The survey plan generation apparatus according to claim 1,
wherein the survey plan includes at least one of a survey schedule, a survey target building list per day, or allocation information on the surveyors or the survey teams.

7. The survey plan generation apparatus according to claim 1,
wherein the at least one processor
displays a survey schedule table for each surveyor or survey team of the survey plan on a display, and
receives edition of the displayed survey schedule table by a user.

8. The survey plan generation apparatus according to claim 7,
wherein the at least one processor receives edition of the survey schedule table by a drag-and-drop operation using a pointing device.

9. The survey plan generation apparatus according to claim 1,
wherein the condition includes at least one of a target number of days, the number of materials, or a priority area.

10. The survey plan generation apparatus according to claim 1,
wherein the survey includes a survey of damage to a plurality of buildings, and
the at least one processor generates the survey plan based on at least one of building information or damage information for each area.

11. The survey plan generation apparatus according to claim 1,
wherein the at least one processor generates the survey plan by using at least one shortest path algorithm of bin packing or Dijkstra's algorithm.

12. The survey plan generation apparatus according to claim 1,
wherein the at least one processor displays the generated survey plan and a map of an area in which the plurality of buildings are included, on a display.

13. A survey plan generation method of generating a survey plan for surveying a plurality of buildings by a plurality of surveyors, the method comprising:
a condition acquisition step of acquiring a condition which is to be satisfied by the survey plan and includes productivity of the plurality of surveyors or productivity of a plurality of survey teams organized by allocating the plurality of surveyors, respectively;
a survey plan generation step of generating the survey plan based on the acquired condition;
a recalculation step of recalculating the productivity of the plurality of surveyors or the productivity of the plurality of survey teams based on survey performances of the plurality of surveyors in a certain period in a survey performed based on the generated survey plan or survey performances of the plurality of survey teams in a certain period; and
a survey plan update step of updating the survey plan based on the recalculated productivity.

14. A non-transitory, computer-readable tangible recording medium on which a program for causing, when read by a computer, the computer to execute the survey plan generation method according to claim 13 is recorded.
